(19) United States
(12) Patent Application Publication
(10) Pub. No.: US 2012/0303833 A1
(43) Pub. Date: Nov. 29, 2012

(54) METHODS FOR TRANSMITTING AND RECEIVING A DIGITAL SIGNAL, TRANSMITTER AND RECEIVER

(75) Inventors: Xiaoming Bao, Singapore (SG); Rongshan Yu, Singapore (SG); Susanto Rahardja, Singapore (SG)

(73) Assignee: AGENCY FOR SCIENCE, TECHNOLOGY AND RESEARCH, Singapore (SG)

(21) Appl. No.: 13/372,010

(22) Filed: Feb. 13, 2012

Related U.S. Application Data
(60) Provisional application No. 61/490,125, filed on May 26, 2011.

(51) Int. Cl. G06F 15/16

(52) U.S. Cl. 709/231

(57) ABSTRACT

According to one embodiment, a method for transmitting a digital signal is provided that includes dividing data representing the digital signal into a plurality of data blocks, processing each data block in accordance with a desired amount of data included in the data block, determining, for each processed data block, the size of the processed data block, generating a message including, in a message body of the message, the processed data blocks and, for each data block, a message field specifying the size of the processed data block and transmitting the message.

### FIELD OF THE INVENTION

Embodiments of the invention generally relate to a method for transmitting a digital signal, a method for receiving a digital signal, a transmitter and a receiver.

### BACKGROUND OF THE INVENTION

With the “HTTP live streaming protocol” and the latest efforts on standardizing “HTTP Streaming of MPEG Media” and HTML5, streaming multimedia over HTTP can be expected to be the trend in the future. There has been increasing demand from industries for efficient delivery of streaming multimedia over HTTP. The current “progressive download” technology used for HTTP streaming may be needed to be upgraded to address the new requirements such as dynamic adaptation of media content in domains of quality/fidelity during delivery based on network conditions and resource capabilities (i.e. adaptive streaming). Specifically, such an upgrade may be of high importance for enabling streaming to mobile devices due to more stringent resource constraints and bandwidth fluctuations of wireless networks.

The concept of adaptive streaming has already existed in a number of commercial streaming systems. In these systems, adaptive streaming is typically implemented with pre-encoding of the same media content into multiple files with different streaming qualities. During the streaming session, the file that best matches the current network conditions is selected as the streaming file. Such an approach not only takes up additional storage space but also complicates the database management at the server side when hosting a large amount of media contents. Besides, this kind of “multiple sources” method usually only provides a few different stream qualities at what can be seen as “coarse granularity” such as low, medium and high to avoid maintaining too many source files for a piece of same media content. Furthermore, the choosing of the stream quality is typically done at the beginning of the transmission of the stream because there is usually no continuous bandwidth monitoring available at the server side.

### SUMMARY OF THE INVENTION

In one embodiment, a method for transmitting a digital signal is provided that includes dividing data representing the digital signal into a plurality of data blocks, processing each data block in accordance with a desired amount of data included in the data block, determining, for each processed data block, the size of the processed data block, generating a message including, in a message body of the message, the processed data blocks and, for each data block, a message field specifying the size of the processed data block and transmitting the message.

According to various embodiments, a receiving method corresponding to the transmitting method described above, a corresponding transmitter and a corresponding receiver are provided.

### SHORT DESCRIPTION OF THE FIGURES

Illustrative embodiments of the invention are explained below with reference to the drawings.

FIG. 1 shows a flow diagram according to an embodiment.

FIG. 2 shows a transmitter for transmitting a digital signal according to an embodiment.

FIG. 3 shows a flow diagram according to an embodiment.

FIG. 4 shows a receiver for receiving a digital signal according to an embodiment.

FIG. 5 shows a communication arrangement according to an embodiment.

FIG. 6 shows a processing flow according to an embodiment.

FIG. 7 shows bandwidth-time diagram.

FIG. 8 shows audio data according to an embodiment.

FIG. 9 shows a first response message and a second response message.

FIG. 10 shows a client station according to an embodiment.

### DETAILED DESCRIPTION

According to various embodiments, a system is proposed that provides a “single source” based method for HTTP adaptive streaming of Fine Granular Scalable (FGS) audio such as MPEG-4 SLS over IP network. “Single source” can be understood as instead of requiring multiple files stored on a server for one media (e.g. audio) content (e.g. one piece of music) only one stored file is required. In addition, according to one embodiment, the server providing the media content is enabled to adjust the stream quality (e.g. audio stream quality) on the fly to avoid re-buffering that may typically be encountered in streaming applications such as online radio services and that may be annoying to the users.

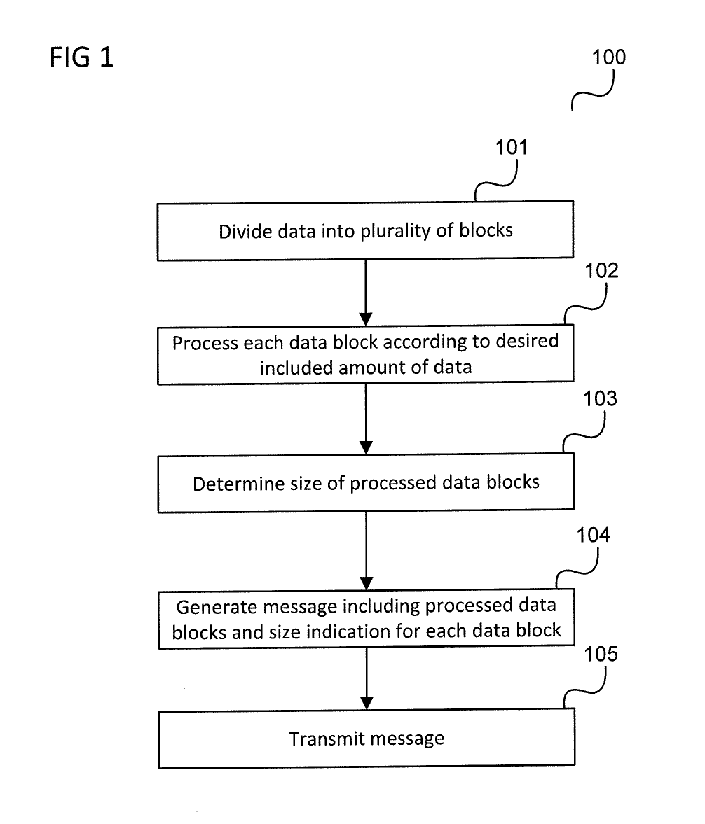

According to one embodiment, a method for transmitting data is provided as illustrated in FIG. 1.

FIG. 1 shows a flow diagram 100 according to an embodiment.

The flow diagram 100 illustrates a method for transmitting a digital signal.

In 101, data representing the digital signal is divided into a plurality of data blocks.

In 102, each data block is processed in accordance with a desired amount of data included in the data block.

In 103, for each processed data block, the size of the processed data block is determined.

In 104, a message is generated including, in a message body of the message, the processed data blocks and, for each data block, a message field specifying the size of the processed data block.

In 105, the message is transmitted.

In one embodiment, in other words, data representing a digital signal (e.g. an encoded version of the digital signal, such as an encoded bit stream representing the digital signal) is separated into blocks (e.g. a sequence of blocks corresponding to sequential parts of the digital signal such as sequential frames), the size of each block is, if necessary, adjusted in accordance with a desired amount of data included in the data block (e.g. corresponding to a desired quality level of the digital signal when being reconstructed from the data) and the processed data blocks are included as parts in an overall message body, wherein each processed data block has its own size indication. Each data block may correspond to a certain time period of the digital signal such that each amount of data corresponds to a data rate of the reconstructed digital signal. For example, each data block corresponds to one or more frames such that each amount of data corresponds to a certain amount of data per frame and thus to a certain data rate of the digital signal reconstructed from the transmitted data.

In one embodiment, the size of each data block is adjusted (or set) in accordance of a data rate adaptation of the data representing the digital signal. According to one embodiment, the size indication (e.g. length information) of a data block (also for example referred to as a chunk) is set only after the rate adaptation of the data (e.g. FGS encoded audio data) within this chunk has been completed. According to one embodiment, this is used to enable carrying FGS encoded audio through HTTP chunk encoded data transmission.

The digital signal is for example a digital audio signal or a digital video signal. Generally, the digital signal may be a digital signal to be transmitted in real-time, i.e. a digital signal that has an associated playback speed and that is to be transmitted such that it can be reconstructed and played at a receiver at the associated playback speed (for example without rebuffering).

In one embodiment, for each data block, processing of the data block includes reducing the amount of the data included in the data block such that the data block includes the desired amount of data if the amount of data included in the data block is higher than the desired amount of data included in the data block.

According to one embodiment, the digital signal is encoded in accordance with a scalable coding method (such as MPEG-4 SLS) to generate the data representing the digital signal. It should be noted that the data to be transmitted (e.g. streamed), i.e. the data representing the digital signal may be a stored scalably encoded digital signal, e.g. a pre-stored scalably encoded digital signal representing a whole piece of music or a whole video clip (generally e.g. a whole media data file). In other words, for example, the data representing the digital signal is for example not data generated by a real-time encoder with encoding rate adapting on the fly based on bandwidth information but is for example pre-generated data representing the digital signal, e.g. data pre-generated before the receipt of the transmission of the digital signal (e.g. a request by a communication terminal for transmission of the digital signal) or data pre-generated (e.g. for a complete piece of music or a complete media data file) before the beginning of the transmission process (e.g. before the first part of the data is transmitted).

In one embodiment, for each data block, processing of the data block includes reducing the amount of the data included in the data block such that the data block includes the desired amount of data in accordance with the scalability provided by the scalable coding method if the data block includes more data than the desired amount of data included in the data block.

Each data block for example includes an encoded bit stream according to the scalable coding method as the data representing the digital signal and wherein, for each data block, processing of the data block includes truncating the encoded bit stream to the desired amount of data included in the data block if the amount of data included in the data block is higher than the desired amount of data included in the data block.

The message is for example generated according to an application layer protocol. For example, the message is generated according to HTTP (Hypertext Transfer Protocol).

According to one embodiment, the message is generated according to chunked transfer encoding, wherein each processed data block corresponds to a chunk.

The message for example includes a message header. The message fields specifying the sizes of the data blocks are for example not included in the (overall) message header of the message but, for each data block, the specification of the size of the data blocks is included in a message field associated with the data block in the message body, for example in a message field preceding the data block in the message body.

Each data block for example includes data representing one or more frames of the digital signal.

According to one embodiment, dividing the data representing the digital signal into a plurality of data blocks comprises dividing the data representing the digital signal into a sequence of data blocks.

According to one embodiment, dividing the data representing the digital signal into a plurality of data blocks comprises dividing the data representing the digital signal into a plurality of data blocks representing sequential parts of the digital signal.

The method may further comprise, for each data block, determining an available data transmission rate for the transmission of the data block and determining the desired amount of data included in the data block based on the available data rate.

The message is for example transmitted by a transmitter and determining the available data transmission rate for example comprises determining the transmission bandwidth of a communication channel between the transmitter and a receiver of the data blocks.

According to one embodiment, the data included in each data block represents one or more frames of the digital signal, the digital signal has an associated frame rate and, for each data block, the desired amount of data included in the data block is determined such that the processed data block can be transmitted using the determined available data transmission rate such that the frames are transmitted at the associated frame rate.

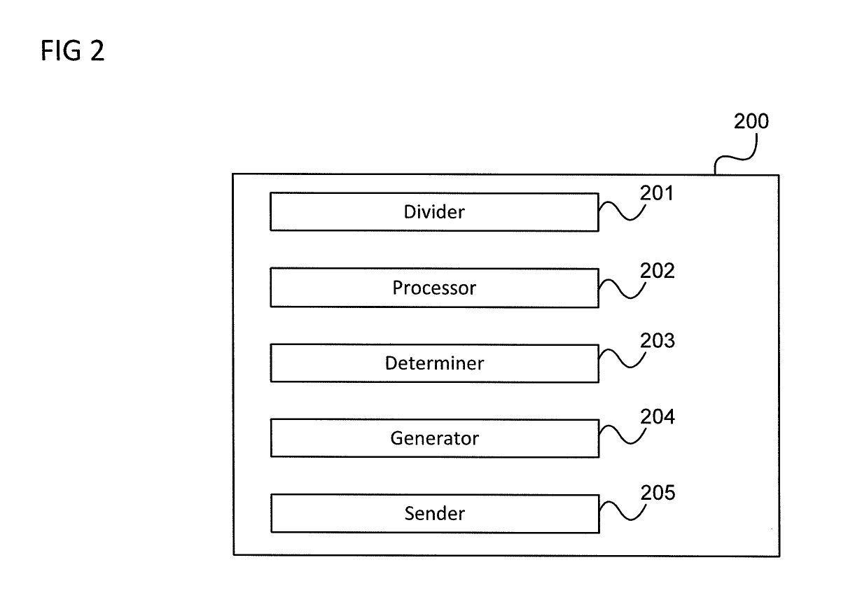

The flow illustrated in the flow diagram 100 is for example carried out by a transmitter (e.g. a server computer) as illustrated in FIG. 2.

FIG. 2 shows a transmitter 200 for transmitting a digital signal according to an embodiment.

The transmitter includes a divider 201 configured to divide data representing the digital signal into a plurality of data blocks and a processor 202 configured to process each data block in accordance with a desired amount of data included in the data block.

The transmitter further comprises a determiner 203 configured to determine, for each processed data block, the size of the processed data block and a generator 204 configured to generate a message including, in a message body of the message, the processed data blocks and, for each data block, a message field specifying the size of the processed data block.

Further, the transmitter comprises a sender 205 configured to transmit the message.

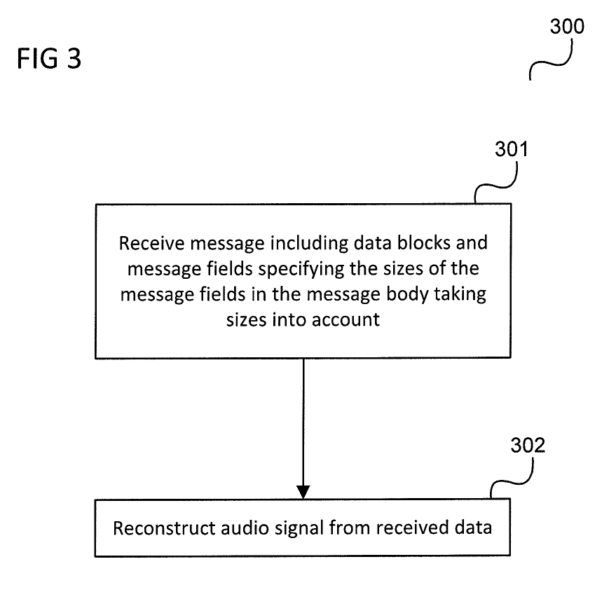

The message is for example received in accordance with a receiving method as illustrated in FIG. 3.

FIG. 3 shows a flow diagram 300 according to an embodiment.

The flow diagram 300 illustrates a method for receiving a digital signal.

In 301, a message is received, including, in a message body of the message, a plurality of data blocks including data representing the digital signal and, for each data block, a message field specifying the size of the data block taking the sizes of the data blocks into account.

In 302, the digital signal is reconstructed from the data included in the plurality of data blocks.

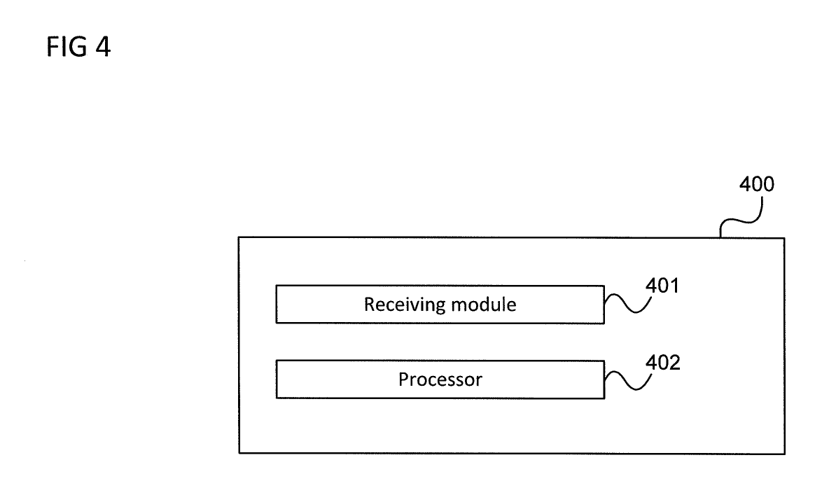

The flow illustrated in FIG. 3 is for example carried out by a receiver (e.g. a client station) as illustrated in FIG. 4.

FIG. 4 shows a receiver 400 for receiving a digital signal according to an embodiment.

The receiver 400 includes a receiving module 401 configured to receive a message, including, in a message body of the message, a plurality of data blocks including data representing the digital signal and, for each data block, a message field specifying the size of the data block taking the sizes of the data blocks into account.

The receiver 400 further includes a processor 402 configured to reconstruct the digital signal from the data included in the plurality of data blocks.

It should be noted that according to various embodiments, computer program elements which, when executed by a computer (including e.g. a smartphone), make the computer perform the method for transmitting a digital signal and the method for receiving a digital signal as described above with reference to FIGS. 1 and 3 are provided.

In the following, embodiments are described in more detail.

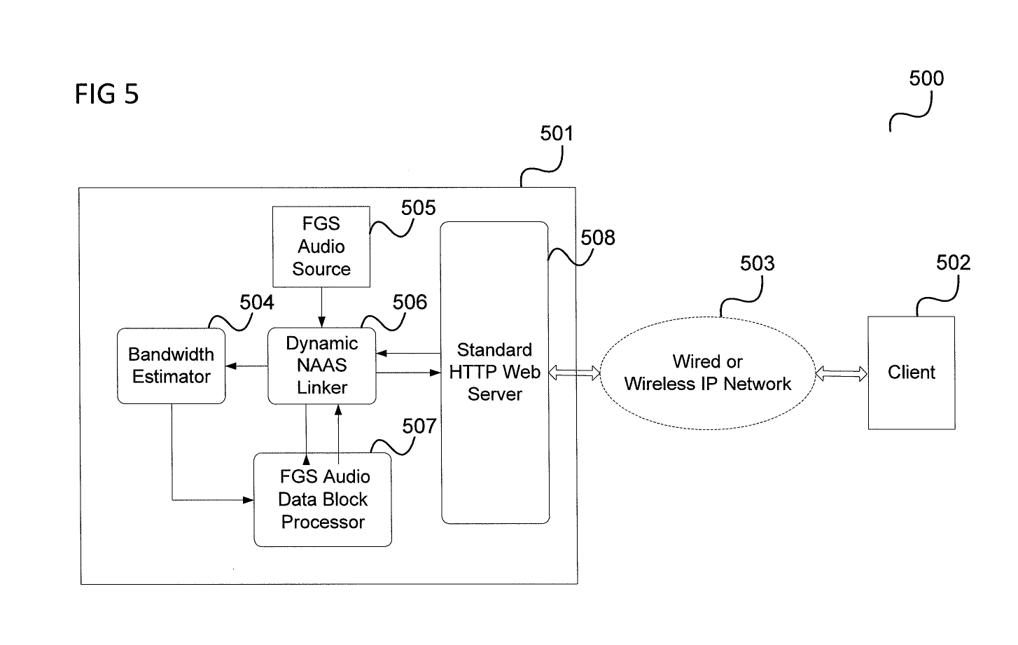

Various embodiments provide a practical system solution to Network Adaptive Audio Streaming (NAAS). It may include a TCP-based bandwidth estimator, a dynamic NAAS linker to a HTTP web server which may be seen as a standard HTTP server, an FGS audio data block processor, and a customized streaming client. Such an architecture is illustrated in FIG. 5.

FIG. 5 shows a communication arrangement 500 according to an embodiment.

The communication arrangement 500 comprises a server station 501 (e.g. a server computer) and a client station 502 (e.g. a mobile phone such as a smartphone).

The server station 501 and the client station 502 are connected by a communication network 503, e.g. a wired or wireless IP (Internet Protocol) network.

The server station 501 comprises a bandwidth estimator 504, a media source 505, in this example a source of FGS (Fine Granular Scalable) audio data, i.e. scalably encoded audio data, a linking component 506, in this example a dynamic NAAS linker, a media data processor 507, in this example an FGS audio data block processor, and an HTTP web server 508.

The server station 501 can be seen to implement an adaptive streaming system.

According to one embodiment, the adaptive streaming system works with a standard HTTP web server 508 without affecting any other function of the HTTP web server 508. In one embodiment, this is achieved by providing the bandwidth estimator 504 and the FGS audio data block processor 507, e.g. implemented by means of two software modules added to the HTTP web server software.

The bandwidth estimator 504 estimates in real-time the available streaming bandwidth between the server station 501 and the client station 502 and the FGS audio data block processor 507 truncates FGS audio data provided by the media source 505 according to the estimated available streaming bandwidth to ensure that the data rate of the audio data streamed from the server station 501 to the client station 502 is close (e.g. as close as possible, i.e. optimally close) to the available streaming bandwidth. For example, software modules with which the bandwidth estimator 504 and the FGS audio data block processor 507 are implemented are dynamically linked to the HTTP web server 508 via software hooking (i.e. a specific software interfacing technique).

It should be noted that in a conventional HTTP based streaming system, the media data being streamed may be typically transmitted in the form of HTTP messages for which the length of the message body is signaled by means of a fixed, predetermined data element before the message body. According to one embodiment, as the length of FGS audio data is dynamic due to the truncation operation, a solution is provided that allows to effectively transmit FGS audio data with variable length information by means of HTTP messages. Specifically, according to one embodiment FGS audio data (e.g. an audio signal corresponding to a piece of music) are partitioned into a series (or sequence) of data blocks and each data block is transmitted in a separate chunk of a HTTP message according to HTTP chunked transfer encoding.

According to one embodiment, the length information of a chunk is set only after the rate adaptation of the FGS audio data within this chunk message so that the chunk contains the correct length information.

The HTTP web server 508 may be a standard HTTP web server (e.g. implemented as an Apache Server) that does not provide adaptive streaming features (by itself). According to one embodiment, the functionality of adaptive streaming is added to the HTTP web server 508 by modifying and including new functions directly to program code of the HTTP server 508 (if available) and rebuilding the server software. According to another embodiment, a more practical way may be used: In an Apache server, for example, at certain stages of the process, customized software modules can be “hooked” to the server at run time in order to perform certain customized functions. These customized modules can be developed and built independently into a DLL (dynamic link library) like binary file and can be loaded by the server software at run time. In this way, the server capabilities can be extended by the functionality of adaptive streaming without touching any part of the HTTP server 508 and thus system deployment can be significantly simplified.

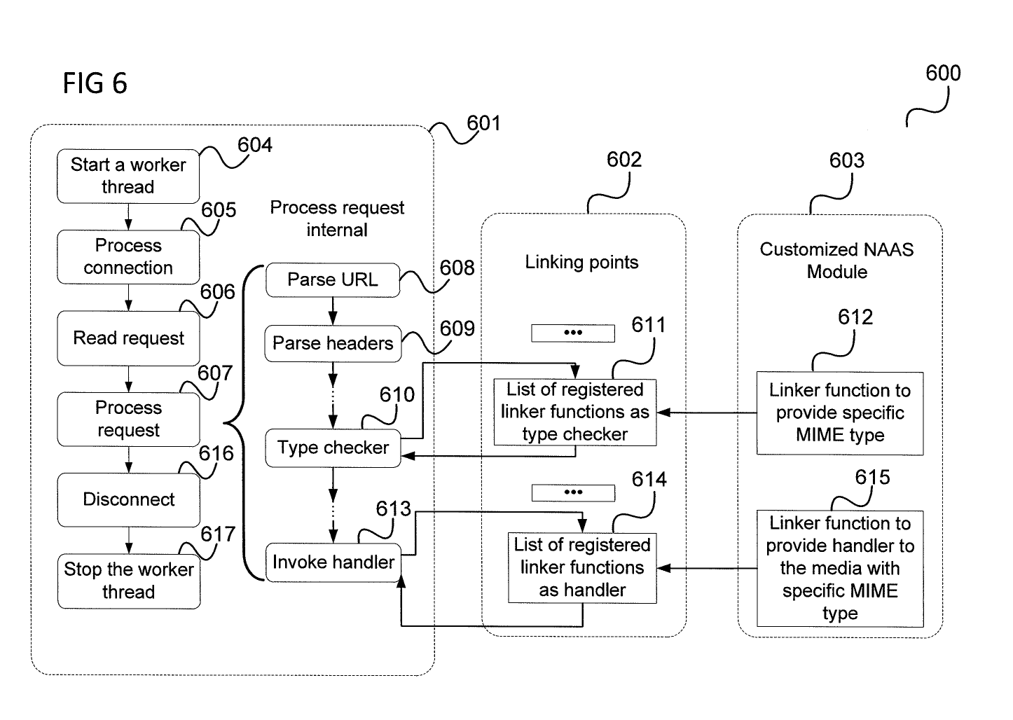

The dynamic linking of a customized module for providing adaptive streaming (also referred to as the customized NAAS module in the following) is illustrated in FIG. 6.

FIG. 6 shows a processing flow 600 according to an embodiment.

The processing flow 600 is carried out by a server 601, e.g. corresponding to the HTTP web server 508, a customized NAAS module 603 and linking points 602 between the server 601 and the (customized) NAAS module 603.

In 604, a worker thread is started.

In 605, a process connection is carried out, e.g. the server 601 connects to the communication network 503 to be able to receive requests for media data (e.g. audio files).

In 606, a read request is received, e.g. a request from the client station 502 for media data.

In 607, the request is processed. This may involve, in 608, a processing of the URL (Uniform Resource Locator) specified in the request and a processing of one or more headers of the request in 609. Further, in 610, the type of the requested data is checked. For this, a list of linker functions registered as type checker 611 may be checked at linking points 602. For a specific data type (e.g. MIME, Multipurpose Internet Mail Extensions, type) that is supported (i.e. for which a linker function is registered as handler) the linker function 612 to handle the specific data type is provided by the customized NAAS module 603.

In 613, after type checking, the handler for the requested data is invoked. For this, the linking points 602 provide a list of linker functions registered as handler 614. The customized NAAS module 603 provides the linker functions 615 that are registered as handler for the data.

In 616, the server 601 disconnects from the communication network 503 and the worker thread is stopped in 617.

For the dynamical linking to the server at the different stages in the process of handling a (HTTP) request for FGS audio data, firstly, a linker function is registered as type checker to add a specific MIME type “application/x-sls-audio” for MPEG-4 SLS bit-stream to the request record structure, i.e. is added to the list of linker functions registered as type checker 611. Secondly, another linker function is registered as handler to handle client requests for data with MIME type “application/x-sls-audio”, i.e. is added to the list of linker functions registered as handler 614.

When the server receives a client request for FGS audio in 606, it runs through the illustrated process steps described above, wherein the linker function registered as type checker to add a specific MIME type “application/x-sls-audio” is called when the server runs to the linking point where, in 610, all the linker functions registered as type checker are examined. Finally, when the server runs to the handler linking point, in 613, the linker function registered as handler to handle client requests for data with MIME type “application/x-sls-audio” competes with the other registered handlers to take over the tasks in handling the request for FGS audio.

After the customized NAAS module 603 has been dynamically linked to HTTP server 601, it extends the capability of the server 601 to make it an adaptive streaming server for FGS audio while all the other standard functions in the server can be left intact. For example, the server 601 can still provide web pages to the client station 502 using a web browser.

According to one embodiment, the bandwidth estimator 504 provides a TCP-based network bandwidth estimation to the media data processor. Network bandwidth estimation may for example be used for routing algorithms and congestion control mechanisms in traffic engineering. Techniques and tools for network bandwidth estimation typically use active probing to measure bandwidth related metrics. Further, for example, the idle rate of a wireless link may be calculated to estimate an available bandwidth. This, however, requires adding a module to the MAC (Medium Access Control) layer of each node in the network in order to get the idle rate.

According to one embodiment, instead of accessing the MAC layer, a more practical way is to estimate the available bandwidth at transport layer. A UDP (User Datagram Protocol) based video transport protocol (VTP) uses the timestamp information contained in the specially designed control packet to calculate the available bandwidth. In various embodiments, the acknowledgement mechanism in TCP is used to get the required information to estimate the available bandwidth instead of proposing a new transport protocol, which is more practical in system implementation and deployment.

The sequence number in a TCP response is the number of received bytes acknowledged by the receiver. Let sᵢ be the sequence number acknowledged at time tᵢ, sᵢ₋₁ be the sequence number acknowledged at time tᵢ₋₁, then the available bandwidth bᵢ at time tᵢ can be estimated by

$${b}_{i} = \frac{{s}_{i} - {s}_{i - 1}}{{t}_{i} - {t}_{i - 1}} \qquad ( 1 )$$

According to one embodiment, to reduce the noise in estimated bandwidth and avoid rapid fluctuation in stream quality, a low pass filter is applied by smoothing the estimated bandwidth:

b̅ᵢ̅=αᵢ b̅ᵢ̅₋̅₁̅+(1−αᵢ)bᵢ (2)

where αᵢ is the weighting coefficient between 0 and 1, which is dependent on Δᵢ=tᵢ−tᵢ₋₁.

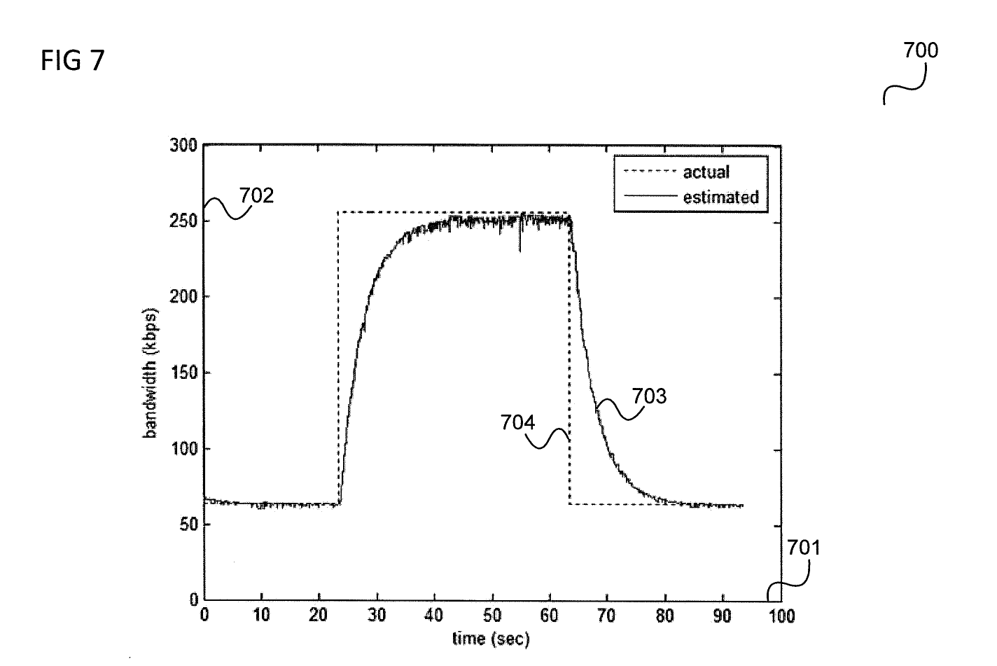

According to one embodiment, the bandwidth estimation algorithm for NAAS is carried out in accordance with equations (1) and (2). The behavior of the bandwidth estimation algorithm is illustrated in FIG. 7.

FIG. 7 shows bandwidth-time diagram 700.

Time is given (in seconds) along a time axis 701 and bandwidth is given (in kbps) along a bandwidth axis 702.

The actual bandwidth is in this example given as a dashed line 704 and the bandwidth estimated by the bandwidth estimation algorithm is given as a solid line 703.

As can be seen, FIG. 7 illustrates the step response of the bandwidth estimation algorithm to the change of the actual bandwidth from 64 kbps to 256 kbps at 24 seconds and from 256 kbps back to 64 kbps at 64 seconds during a streaming process.

It should be noted that the above bandwidth estimation algorithm is described here for illustration purpose and other bandwidth estimation algorithms may be used according to various embodiments.

According to one embodiment, the FGS audio is encoded according to MPEG-4 scalable lossless (SLS) coding. MPEG-4 scalable lossless (SLS) coding was one of the latest additions to the MPEG-4 audio coding tool family from ISO/IEC. It allows the scaling up of a perceptually coded representation such as MPEG-4 AAC to a lossless representation with a wide range of intermediate bit-rate representations. It also has a non-core mode in which the MPEG-4 AAC core is not present, and the quality is scaled up virtually from 0 kbps.

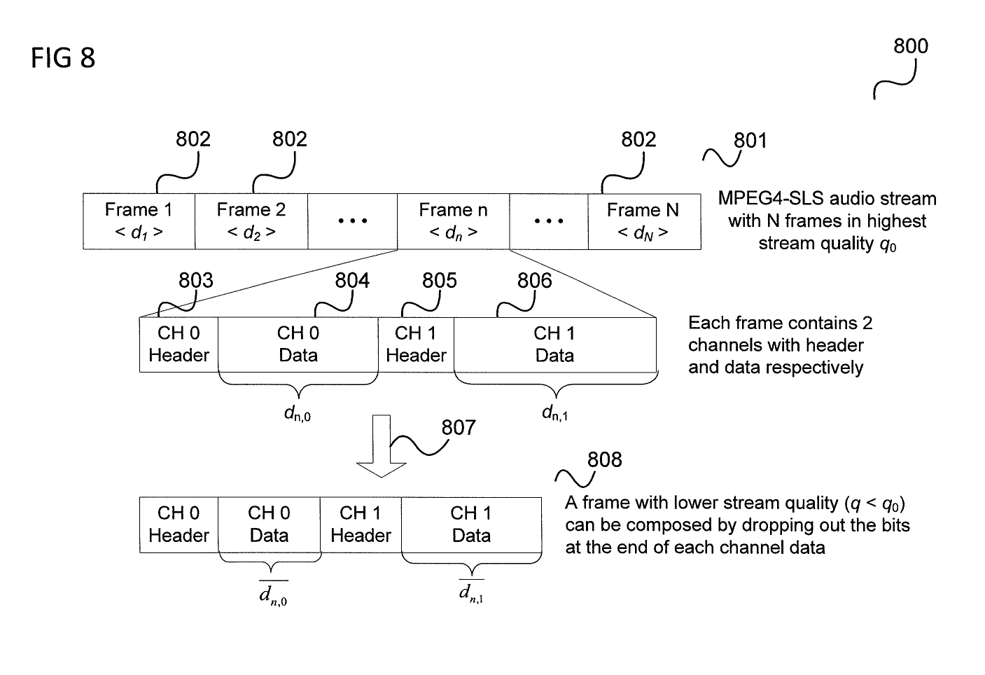

One of the major merits of MPEG-4 SLS can be seen in that the bit-stream generated from the encoder can be further truncated to lower data rates easily by dropping bits at the end of each frame. This is illustrated in FIG. 8.

FIG. 8 shows audio data according to an embodiment.

In a first format 801, the audio data includes a losslessly encoded audio signal (or more generally the audio signal with highest quality) and is for example stored by the audio source 505. According to the first format 801, the audio data includes audio data for each frame 802 of a plurality of frames (N frames in this example). The audio data has the form of an MPEG4-SLS audio stream, such that the audio data for each frame 802 are arranged in a sequence in the stream.

The audio data for each frame 802 include a first header 803 for a first channel, first data 804 for a first channel, a second header 805 for a second channel and second data 806 for a second channel.

The audio data for each frame 802 also form a sequence, e.g. a bit stream, such that the whole audio data form an overall bit stream.

For the audio data for each frame 802, the first data 804 and the second data 806 also form a bit stream and may be truncated at the end such that the data for the frame 802 may be reduced. This truncation process is illustrated by an arrow 807 and is for example carried out by the data processor 507.

The result of the truncation is a second format 808 in which, as illustrated, the first data 804 and the second data 806 for the two channels for each frame 802 are reduced which leads to a quality of the encoded audio signal that is lower than the original quality.

In other words, an encoded audio signal with lower data rate can be generated from the original encoded audio signal (with highest quality) by dropping bits at the end of each channel data bit stream.

Here, the term data rate is used as well as media rate to denote the number of bits or bytes per audio frame duration being, for example, provided by the server station 501, transmitted and eventually processed by the decoder of the client station 502. The higher the audio stream quality, the higher the media rate (data rate). According to one embodiment, HTTP adaptive streaming includes determining the media rate according to the estimated available network bandwidth so that media rate is always equal or less than the network bandwidth (available for the transmission of the encoded audio signal) in order to make sure the smooth playback of the audio stream at the client side.

For example, according to one embodiment, once the linker function registered as handler to handle client requests for data with MIME type “application/x-sls-audio” (also referred to as the NAAS handler) has captured the client request for FGS audio, it starts a separate thread to estimate the available bandwidth of the link using, e.g. using the bandwidth estimation method as described above with reference to equations (1) and (2). Meanwhile, it composes response message headers and the response message body. The response message body contains the requested FGS audio data that are read from the source audio data file provided by the media (in this example audio) source 505.

In non-adaptive (fixed bit rate) cases such as in a non-adaptive streaming applications, the length of the message body can be calculated in advance and included in the “Content-Length” response message header. Typically, a client station needs to be signaled with this value before it starts to receive the following-up message body. Otherwise, either a premature termination of the HTTP connection or a time-out may occur where in both cases a client station will not be able to get the response message body correctly.

However, since the NAAS handler may truncate the FGS audio data of at least some of the frames in the audio data stream to be included in the response message due to an available network bandwidth that is insufficient for the audio data with highest encoding quality, it may not be possible to determine the amount of data in the response message in advance.

Accordingly, in one embodiment, the NAAS module 603, in order to overcome the requirement of signaling a fixed and pre-determined Content-Length message header according to HTTP protocol, uses the Chunked Transfer-Encoding mechanism according to HTTP/1.1 to support the adaptive streaming functionality of NAAS.

For this, according to one embodiment, the whole message body, which contains the compressed scalable encoded audio data (with highest quality, i.e. not yet truncated), is split into a number of smaller data blocks (chunks), each block containing the data of an integer number of FGS audio frames. The adjustment of media rate of the audio stream (i.e. the truncation) is performed for each data block before it is transmitted. After that, the size of the data block is re-calculated and inserted in the beginning of the data block. This inserted data block size is signaled with the HTTP/1.1 Transfer-Encoding: Chunked message header and hence does not interfere the normal progressive downloading function of a HTTP/1.1 compliant client.

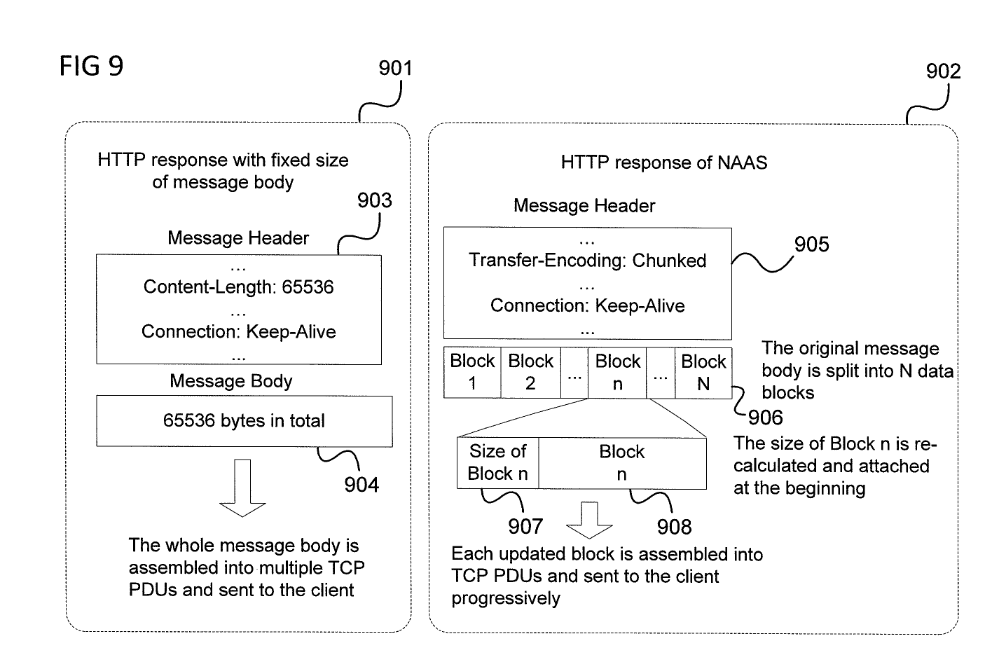

In this way, according to one embodiment, all the data blocks are sent to the client station 502 one by one independently and progressively without the need to inform the client about the size of the whole message in advance. This is illustrated in FIG. 9.

FIG. 9 shows a first response message 901 and a second response message 902.

The first response message 901 can be seen to correspond to the case that the size of the whole message is known before start of the transmission, or in other words, to a fixed length of the audio stream. Accordingly, the size of the message (in this example 65536 byte) can be inserted into a header 903 of the first response message 901. A message body 904 of the first response message includes the audio data.

The second response message 902 can be seen to correspond to adaptive streaming. The original audio stream (i.e. the audio stream corresponding to highest quality) is split into data blocks, each data block is processed by truncating the audio data included in the data block depending on the network bandwidth currently available for the transmission of the data block and an indication of the amount of data 908 of the processed data block is included in a data block header 907 of the data block.

A header 905 of the second message 902 includes the indication that the message has been generated according to HTTP chunked transfer encoding and a body 906 of the second message includes the data blocks.

The processed blocks are transmitted progressively, i.e. sequentially, to the client station 502 by means of TCP (Transport Control Protocol) PDUs (Packet Data Units). According to one embodiment, the media rate is adjusted by the FGS audio data block processor 507 according to the estimated available network bandwidth b̅ᵢ̅ at time tᵢ so as to keep smooth playing of the audio stream at the client side.

The media rate can for example be adjusted based on the following calculations:

1) Determine the average frame size d̅ᵢ̅ to be sent out from tᵢ to tᵢ₊₁.

d̅ᵢ̅= b̅ᵢ̅×1024/f₀

where f₀ is the sampling frequency (i.e. the number of frames per second of the encoded audio signal) and b̅ᵢ̅ is the smoothed available network bandwidth.

2) Determine the truncation rate λᵢⱼ for each frame between tᵢ and tᵢ₊₁.

Assume there are J frames between tᵢ and tᵢ₊₁ let dᵢⱼ be the frame size of the j^{th} frame (jεJ) then set

λᵢⱼ=η× d̅ᵢ̅/dᵢⱼ

where η is a constant coefficient between 0.9 and 1 to make sure the media rate being sent out does not exceed the available bandwidth so as to keep the playback on the client side smooth. An upper bound and a lower bound may be applied to the λᵢⱼ such that it is ensured that

λₘᵢₙ≦λᵢⱼ≦1.

3) Adjust the media rate

For the j^{th} frame (jεJ) between tᵢ and tᵢ₊₁,

dᵢⱼ=h+dᵢⱼ₀+dᵢⱼ₁

where h is a constant representing the header size, dᵢⱼ₀ is the data size for channel 0, and dᵢⱼ₁ is the data size for channel 1. The new channel 0 data size and the new channel 1 data size of the frame (after truncation) may be calculated as

d̅ᵢ̅ⱼ̅₀̅=λᵢⱼ×dᵢⱼ₀, d̅ᵢ̅ⱼ̅₁̅=λᵢⱼ×dᵢⱼ₁.

Finally the adjusted frame size based on the available bandwidth b̅ᵢ̅ may be calculated as

d̅ᵢ̅ⱼ̅=h+ d̅ᵢ̅ⱼ̅₀̅+ d̅ᵢ̅ⱼ̅₁̅.

It should be noted that the above media rate adjustment method is included here for illustration purpose and other media rate adjustment algorithms may be used in the adaptive streaming system according to various embodiments.

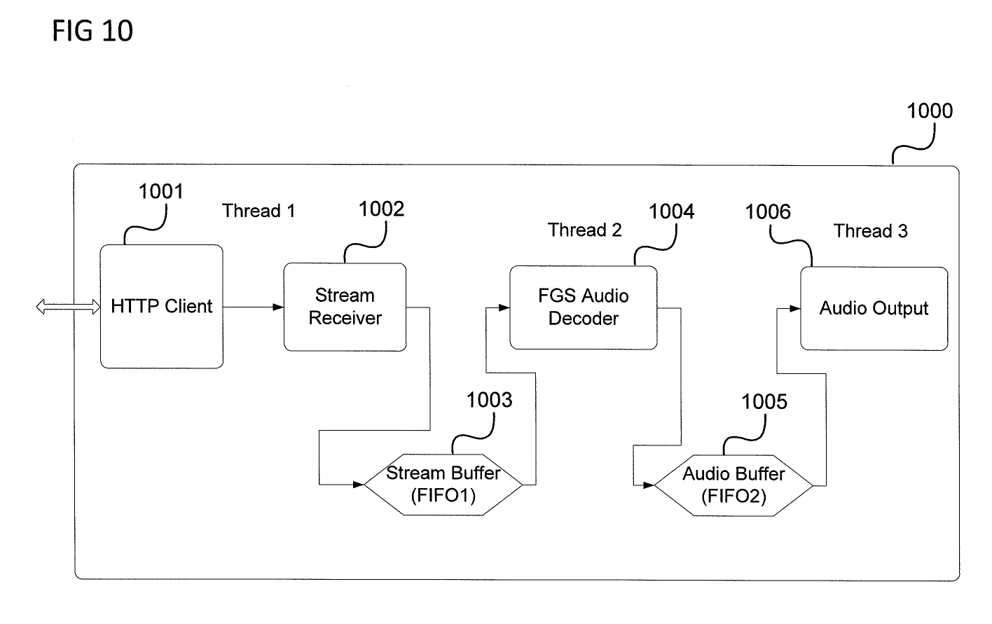

The client station 502 may for example have a structure as illustrated in FIG. 10.

FIG. 10 shows a client station 1000 according to an embodiment.

According to one embodiment, the client station 1000 acts as a media player for the adaptive streaming system described above with reference to FIG. 5 and corresponds to the client station 502. According to one embodiment, the client station 1000 may be seen as a typical HTTP based streaming client.

According to one embodiment, for operating as the client for the adaptive streaming system, the client station 1000 carries out three processes: a receiving process, a decoding process and an audio output process (referred to as threads 1 to 3 in FIG. 10).

For this, the client station 1000 includes an HTTP client 1001 which may for example start the streaming process by sending an HTTP request for FGS audio data.

Two FIFO (First In First Out) memories are allocated as stream buffer and audio buffer respectively.

As illustrated in FIG. 9, in the header 905 of the response message 902 it is signaled by the NAAS HTTP streaming server 901 that the incoming message body is Chunked Transfer Encoded.

The HTTP client 1001 retrieves the data block size inserted into the data block header 907 (at the beginning of each data block) and use it to read the data correctly from the data blocks block by block until an EOF (End of File) syntax is received.

A stream receiver 1002 retrieves the FGS audio frames contained in the data blocks and pushes them one by one into a stream buffer 1003. An FGS Audio Decoder 1004 process fetches the FGS audio frames from the stream buffer 1003, decodes the audio data of each frame and pushes the decoded audio data, in this case PCM (Pulse Code Modulation) audio samples, into an audio buffer 1005. An audio output 1006 plays the decoded FGS audio by reading the PCM audio samples from the audio buffer 1005 and for example passes them to a sound output device.

The adaptive audio (or generally media such as video) streaming system according to various embodiments as described above may be implemented using different communication network environments such as in a local area WiFi network with dedicated wireless router, in a shared office or building WiFi network, or in a 3G wireless network operated by local service provider. In an office WiFi network, for example, when bandwidth is high, the server station 501 responds to the available high TCP throughput by adjusting the bit stream to the highest quality (λ=1). When the bandwidth is reduced to for example 64 kbps (as illustrated in FIG. 7), the server station 501 may reduce the sending bit rate by lowering the stream quality accordingly. After the bandwidth has recovered, the server station 501 can adjusts the bit stream to highest quality again. As another example, in the case of a 3G wireless network, the bandwidth may for example keep fluctuating around 160 kbps and the server station 501 keeps adjusting the bit-rate of the streamed MPEG-4 SLS bit-stream to fit into the available bandwidth. In both cases, the playback on the client station 502 is smooth and the user does not encounter re-buffering.

1. A method for transmitting a digital signal comprising:
dividing data representing the digital signal into a plurality of data blocks;
processing each data block in accordance with a desired amount of data included in the data block;
determining, for each processed data block, the size of the processed data block;
generating a message including, in a message body of the message, the processed data blocks and, for each data block, a message field specifying the size of the processed data block; and
transmitting the message.

2. The method according to claim 1, wherein the digital signal is a digital audio signal or a digital video signal.

3. The method according to claim 1, wherein, for each data block, processing of the data block includes reducing the amount of the data included in the data block such that the data block includes the desired amount of data if the amount of data included in the data block is higher than the desired amount of data included in the data block.

4. The method according to claim 1, wherein the digital signal is encoded in accordance with a scalable coding method to generate the data representing the digital signal.

5. The method according to claim 4, wherein, for each data block, processing of the data block includes reducing the amount of the data included in the data block such that the data block includes the desired amount of data in accordance with the scalability provided by the scalable coding method if the amount of data included in the data block is higher than the desired amount of data included in the data block.

6. The method according to claim 4, wherein each data block includes an encoded bit stream according to the scalable coding method as the data representing the digital signal and wherein, for each data block, processing of the data block includes truncating the encoded bit stream to the desired amount of data included in the data block if the amount of data included in the data block is higher than the desired amount of data included in the data block.

7. The method according to claim 1, wherein the message is generated according to an application layer protocol.

8. The method according to claim 1, wherein the message is generated according to HTTP.

9. The method according to claim 1, wherein the message is generated according to chunked transfer encoding, wherein each processed data block corresponds to a chunk.

10. The method according to claim 1, wherein the message includes a message header.

11. The method according to claim 1, wherein each data block includes data representing one or more frames of the digital signal.

12. The method according to claim 1, wherein dividing the data representing the digital signal into a plurality of data blocks comprises dividing the data representing the digital signal into a sequence of data blocks.

13. The method according to claim 1, wherein dividing the data representing the digital signal into a plurality of data blocks comprises dividing the data representing the digital signal into a plurality of data blocks representing sequential parts of the digital signal.

14. The method according to claim 1, further comprising, for each data block, determining an available data transmission rate for the transmission of the data block and determining the desired amount of data included in the data block based on the available data rate.

15. The method according to claim 14, wherein the message is transmitted by a transmitter and wherein determining the available data transmission rate comprises determining the transmission bandwidth of a communication channel between the transmitter and a receiver of the data blocks.

16. The method according to claim 14, wherein the data included in each data block represents one or more frames of the digital signal, the digital signal has an associated frame rate and, for each data block, the desired amount of data included in the data block is determined such that the processed data block can be transmitted using the determined available data transmission rate such that the frames are transmitted at the associated frame rate.

17. A transmitter for transmitting a digital signal comprising:
a divider configured to divide data representing the digital signal into a plurality of data blocks;
a processor configured to process each data block in accordance with a desired amount of data included in the data block;
a determiner configured to determine, for each processed data block, the size of the processed data block;
a generator configured to generate a message including, in a message body of the message, the processed data blocks and, for each data block, a message field specifying the size of the processed data block; and
a sender configured to transmit the message.

18. A method for receiving a digital signal comprising:
receiving a message, including, in a message body of the message, a plurality of data blocks including data representing the digital signal and, for each data block, a message field specifying the size of the data block taking the sizes of the data blocks into account; and
reconstructing the digital signal from the data included in the plurality of data blocks.

19. A receiver for receiving a digital signal comprising:
a receiving module configured to receive a message, including, in a message body of the message, a plurality of data blocks including data representing the digital signal and, for each data block, a message field specifying the size of the data block taking the sizes of the data blocks into account; and
a processor configured to reconstruct the digital signal from the data included in the plurality of data blocks.
